(19) United States
(12) Patent Application Publication
(10) Pub. No.: US 2024/0227879 A1
(43) Pub. Date: Jul. 11, 2024

(54) METHOD FOR AI INSPECTING FASTENER LOOSENING STATUS AND SURVEILLANCE DEVICE THEREFOR

(71) Applicant: BEIJING JIAOTONG UNIVERSITY, Beijing (CN)

(72) Inventors: Zhan GAO, Beijing (CN); Lin DENG, Beijing (CN); Ye SA, Beijing (CN); Qibo FENG, Beijing (CN)

(21) Appl. No.: 18/143,637

(22) Filed: May 5, 2023

(30) Foreign Application Priority Data
Jan. 8, 2023 (CN) 202310022884.X

(51) Int. Cl. B61K 9/08; G01B 9/02; G01B 11/16; G06T 7/00; G06T 7/40; H04N 25/71

(52) U.S. Cl. CPC B61K 9/08; G01B 9/02083; G01B 11/162; G06T 7/0002; G06T 7/40; H04N 25/71; G06T 2207/20081; G06T 2207/20224; G06T 2207/30232; G06T 2207/30252

(57) ABSTRACT

A method for AI real-time inspecting a fastener loosening status, in which a light intensity matrix of a fastener being detected and its adjacent surfaces is obtained via a laser irradiation and an area scan camera system in order to obtain any possible loosening information blow any surface; a correspondence between a speckle texture map and a fastener loosening status is established directly through machine learning of AI, so that the loosening status of any fastener is identified not by any conventional phase extracting technique but by an AI judgement model. According to the present invention, any status at a certain depth below a surface can be detected, and even any status that some fastener is about to be loosened but has not yet actually deformed can also be detected in advance; and a detecting efficiency and accuracy can surpass an ability of skilled human workers.

### TECHNOLOGY FIELD

The present invention relates to an AI inspection method and equipment for detecting a fastener loosening status, and specifically relates to real-time detection methods and devices for inspecting a fastener connection firmness, and especially relates to the application of AI machine learning in the field of updating real-time, non-contact detection methods for monitoring railroad rail fastener loosening state.

### BACKGROUND TECHNOLOGY

Fasteners are important basic parts of equipment in the fields of aerospace, rail transportation, machinery manufacturing, etc. They can effectively connect multiple parts together to form a new system and are currently one of the main connection methods. Many fasteners have the advantages of removable and replaceable, but also easy to loosen and cause hidden problems. It's necessary for regular loosening detection of fasteners to ensure the normal and safe operation of the entire system.

Railroad fasteners are fixed to the rail on the rail sleeper, to maintain the gauge and prevent the rail from moving relative to the rail sleeper parts, the system is unified, widely used, is one of the representative fasteners. It can ensure the safety of railroad operation and reduce the vibration of the track. But the fastener may become loose due to the vibration of the train through, seriously affect the safety of railroad operation. Especially trains are traveling at a higher speed with heavier loads nowadays, the vibration is more intense at higher frequencies, and fasteners become loose at higher rates. So regular inspection of the railroad fastener status is necessary. At present, the fastener detection mainly relies on manual, but there are many shortcomings of manual inspection: requires a lot of manpower, slow detection speed, judgment results depending on subjective consciousness and experience, there is a certain degree of danger.

Over the recent years, with the vigorous development of the railroad and high-speed rail business, the development of reliable and practical automatic detection technology for fastener loosening has become very urgent. The current automatic detection technology for fastener loosening state can be divided into sensor-based and three-dimensional vision-based detection methods.

The traditional sensor-based detection method is to use that the fastener loosening will lead to changes in the physical parameters and structural characteristics of the rail to determine the fastener loosening. But the method requires to pre-lay a huge number of specific sensors along the track, which is inconvenient and high cost.

The three-dimensional vision-based detection method is to use the structured light system to obtain the three-dimensional point cloud map of the fastener, and restore the three-dimensional shape of the fastener, according to the height of the bolt or the distance from the center of the spring bar to the bottom of the rail to determine fastener loosening. But this method is not only susceptible to ambient light, and the fastener three-dimensional shape and the metal sling centerline extraction calculation process is also very time-consuming, which cannot meet the requirements of rapid real-time detection.

In addition, in the actual working conditions, possibly, the fastener is already loose but has not yet deformed, the traditional three-dimensional vision detection method based on depth information can't effectively identify the loosening status of this situation.

In prior art to detect the damaged and lost fastener, the two-dimensional image is taken from above, which doesn't contain the depth information of the fastener and its adjacent surfaces, and can't complete the fastener loosening detection which requires the depth information.

### SUMMARY OF THE INVENTION

The object of the present invention is to provide a method and apparatus for detecting any loosening state of a fastener, which is a non-contact, high-precision, fast, and even real-time AI detection method, using a single apparatus to inspect countless fasteners while the apparatus is moving in its way, and pre-identify the working conditions that have begun to loosen but have not yet deformed.

According to the first aspect of the present invention, a fastener loosening AI real-time inspection method is provided, wherein the method comprises:
detecting the stress or strain in and around the fastener (replacing the traditional displacement or deformation);
abandoning the traditional camera and collecting the light intensity distribution of the fastener and the adjacent surface by laser irradiation and a surface array camera system; representing the depth information of the fastener and the adjacent surface by the light intensity distribution of the measured surface;
abandoning the phase extraction technique in the prior art, directly establishing the correspondence between the fringe interferogram and the fastener state through machine learning of AI; conducting fastener loosening state detection through identification of the obtained fringe interferogram;
through the learning of fringe interferogram (e.g., the speckle fringe patterns) under different degrees of loosening of fasteners, also including the machine learning of the state of loosening that has not yet deformed, the AI model can not only determine whether the fastener is loose, but also judge and identify the degree of loosening and issue early warning or alarm.

Preferably, a laser is emitted by a laser, which passes through a beam expander to form a larger diameter laser output beam and irradiates the rough surface of the fastener and its adjacent area; the reflected light from the rough surface of the fastener and its adjacent area passes through a shearing device to form a speckle texture map; the pattern is recorded by a CCD and transmitted to a computer for storage and image processing.

Preferably, a CCD collects the original speckle texture map (e.g., original shearing speckle pattern) with irregular random distribution before and after the deformation; the original speckle texture map is subtracted from the speckle texture map (e.g., shearing speckle pattern) after the deformation to obtain the fringe interferogram which records the phase information of the measured fastener surface, that is the depth information.

Preferably, the shearing device produces a misalignment between the reference light and the interfering light on the imaging surface, thereby producing an interfered speckle pattern; preferably, a reference mirror of the Michelson interferometer is rotated by an angle, so that the two reflected beams are misaligned on the imaging surface, thereby forming an interference.

Preferably, the training process for AI machine learning comprises:
applying loads of different working conditions to the system with fasteners installed from zero-load to critical load, and at the same time, acquiring images of physical parameter changes of the fasteners (e.g., speckle fringe pattern) and transmitting them to the computer; stopping the application of load after each cycle of loading reaches the critical state until the fastener system returns to the initial state and stops image acquisition; repeating the loading and unloading operations until sufficient fastener images of physical parameter changes in the normal state;
loosening the fastener so that it becomes loose; repeating the loading, unloading and image acquisition operations until sufficient images of physical parameter changes in the loosening state of the fastener are acquired; original data set ensures that the images in the normal state of the fastener and the images in the loosened state each account for 50%;
performing filtering, normalizing and other operations on the physical parameter change images using a computer; to label all the physical parameter change images with normal state or loose state respectively; or, to directly label the images of fasteners in the normal state considered by humans with normal state and the images of fasteners in the loose state considered by humans with loose state;
and putting the original data set as a training set into the AI judgment model for training, and saving the described AI judgment model.

According to the second aspect of the present invention, a fastener loosening state AI real-time inspection device is provided, wherein the device comprises:
a laser, which is mounted at a position capable of irradiating the fastener;
a spatial filter and beam expander, which is set in a laser path between the laser and the fastener to filter and expand the laser beam;
an image forming device, which forms two identical, interfering images with phase differences;
an image receiving device, which uses a surface array camera; and
a computer, which has a fastener loosening state real-time inspection AI judgment model, the image is filtered, normalized and put into a trained AI judgment model, and the AI judgment model detects the fastener loosening state in real-time.

Preferably, the laser is a single longitudinal mode semiconductor laser with wavelength of 532 nm.

Preferably, the image forming device preferably comprises two polarizers and a Rochon prism.

According to the third aspect of the present invention, a fastener loosening state AI real-time inspection equipment is provided, wherein the inspection equipment is mounted on an operating vehicle, the inspection equipment comprises:
a laser, which is mounted at a position capable of irradiating the fastener;
a spatial filter and beam expander, which is set in a laser path between the laser and the fastener to filter and expand the laser beam;
an image forming device, which forms two identical, interfering images with a phase difference;
an image receiving device, which uses a surface array camera; and
a computer, which has a fastener loosening state real-time inspection AI judgment model, the image is filtered, normalized and put into a trained s AI judgment model, and the AI judgment model detects the fastener loosening state in real-time.

According to the fourth aspect of the present invention, a fastener loosening state AI real-time inspection vehicle is provided, the inspection vehicle comprises:
a laser, which is mounted at a position capable of irradiating the fastener;
a spatial filter and beam expander, which is set in a laser path between the laser and the fastener to filter and expand the laser beam;
an image forming device which forms two identical, interfering images with a phase difference;
an image receiving device, which uses a surface array camera; and
a computer, which has a fastener loosening state real-time inspection AI judgment model, any taken image is filtered, normalized and put into a trained AI judgment model, which AI judgment model detects the fastener loosening state in real-time.

According to the present invention, a laser technology has a phenomenon of “speckle”, that is, when a laser beam is irradiated on a surface of an object with diffuse reflection, a light reflected from the surface of the object is coherently superimposed in space, and an interference occurs in the whole space, forming randomly distributed bright and dark spots. In recent years, the laser speckle interferometry technique has been widely used for the measurement of physical quantities such as vibration, distance, velocity, flow rate, and displacement due to its advantages of high measurement accuracy, fast measurement speed, low measurement device requirements, and ability to achieve full-field and non-contact measurement.

According to the digital shearing speckle pattern interferometry technique of the present invention, it is very sensitive to a gradient of any small out-of-plane deformation of the measured surface, and can be used to measure the out-of-plane and in-plane displacement components, strain, slope, curvature and vibration of the diffuse surface object, and the speckle texture map taken contains a depth information change of the measured surface, so that a fastener loosening detection based on image processing has a potential to achieve full-field, high-precision, fast, and non-contact measurement. However, in prior art, in the field of the fastener loosening detection technology, especially in the field of railroad rail fastener loosening detection technology, no one has ever thought of, much less tried to use, any digital shearing speckle pattern interferometry.

Machine learning is an advanced method for image classification that extracts features from samples to classify images. In different embodiments of the present invention, a total of three machine learning algorithms, decision tree (DT), support vector machine (SVM) and convolutional neural network (CNN), are used to verify the reliability and generalizability of the present invention. In addition, each of the three algorithms has its own advantages, and different algorithms can be selected according to different practical needs. However, no one in the prior art has ever used a machine learning-based image classification method to automate the detection of the loosening status of fasteners.

The present invention combines the digital shearing speckle pattern interferometry and the machine learning for a fastener loosening detection. Compared with any conventional method, it has advantages of non-contact, high accuracy, and significantly higher detection speed.

In particular, the present invention produces surprised technical effects, that is, it can even detect such a situation that the fastener has been microscopically loosened but has not yet had any visible deformation in actual working conditions, which can't be detected by both traditional naked eye recognition and computer-based 3D vision methods.

In prior art, no one has ever used any digital shearing speckle pattern interferometry for automatic detection of any fastener loosening state (not only detecting a surface state of the fastener, but also detecting an inner state at a certain depth below the surface), nor has anyone used machine learning-based image classification methods for automatic detection of the fastener loosening state (which can not only reach the traditional manual detection level, but also surpass the traditional manual detection in terms of speed and quality; on the contrary, the traditional phase extraction algorithm is time consuming to make it impossible to real-time predict any loosening status during detection), and no one has used both the digital shearing speckle pattern interferometry and machine learning based image classification method for automatic detection of the loosening state of fasteners, and no prior art can achieve the technical effect of the present invention.

In particular, it should be noted that the technical solution of the present invention involves not only mechanical engineering (including metal material engineering), but also optical engineering, AI technology, etc., which involves multiple technical fields such as mechanics, optics, and electricity. Therefore, before the present invention, there was no person who knew multiple technical fields such as mechanical engineering, optical engineering and electrical engineering at the same time, and those skilled in the art knew only one of mechanical engineering, optical engineering and electrical engineering. In contrast, in the present invention, new “those skilled in the art” must be a mechanical engineer, an optical engineer and an AI engineer at the same time; therefore, the inventors of the present application are pioneers as “those skilled in the art” who are familiar with all of at least the three fields at the same time. In the sense of patent law, any hybridization and combination of technologies in different fields to produce unprecedented technical solutions, and to achieve unexpected technical effects, is undoubtedly inventive.

According to the present invention, any influence of mechanical vibration of railway lines and vehicles on the accuracy of inspection is also excluded. The present invention discards any traditional photoshop cameras, and discards any phase extraction techniques in prior art.

In particular, the present invention overcomes a traditional technical prejudice (i.e., a technical bias) and reverses those traditional, backward thinking inertia for relative methodologies; it changes from the traditional logic-based mathematical operation scheme to the AI sensory judgment scheme based on image classification; that is to say, the detecting device in the present invention directly “sees” whether the fastener has been or is about to be loosened, instead of relying on any prior “arithmetic” to make any judgment. This is another inventive concept of the present invention.

According to the invention, the surprised technical effect is that it not only can detect the surface loosening state of the fastener, but also can detect the inner status at different depths below the surface; not only can detect the loosening state that has occurred, but also can predict a possible loosening state that will occur; one single set of surveillance equipment can detect or predict any loosening status in real time for four rows of, at both sides of two rails, countless fasteners.

### BRIEF DESCRIPTION OF THE ACCOMPANYING DRAWINGS

FIG. 1 is a schematic diagram of a Michelson transverse shear device.

FIG. 2a is an original speckle texture map captured by a CCD in the first stage of the speckle field processing in prior art and in the present invention.

FIG. 2b is an interference pattern after subtraction in the second stage of the speckle field processing in the prior art and in the present invention.

FIG. 2c is an interference pattern after filtering and binarization in the third stage of the speckle field processing in the prior art.

FIG. 2d is a phase distribution obtained from the interference pattern in the fourth stage of the speckle field processing in the prior art.

FIG. 3 is an optical path diagram of a fastener loosening status detection system based on a digital shearing speckle pattern interference and machine learning.

FIG. 4 is a schematic diagram of two wavefronts after transverse shearing.

FIG. 5 illustrates a structure of a fastener for a railroad rail.

FIG. 6 is a schematic diagram of an overall testing process according to one of embodiments of the present invention.

FIG. 7 is a flow diagram of the fastener loosening status inspection based on a decision tree according to one embodiment of the present invention.

FIG. 8 is a schematic diagram of a principle of a support vector machine according to one embodiment of the present invention.

FIG. 9 is a schematic diagram of a modified VGG-16 network structure according to one embodiment of the present invention.

FIG. 10a is a schematic view of a laser system of the first embodiment of an inspection device according to the present invention.

FIG. 10b is a schematic view of a laser system of the second embodiment of an inspection device according to the present invention.

FIG. 10c is a schematic view of a laser system of the third embodiment of an inspection device according to the present invention.

FIG. 10d is a schematic view of a laser system of the fourth embodiment of an inspection device according to the present invention.

### BEST MODES FOR CARRYING OUT THE INVENTION

Preferred embodiments are described in detail below with the example drawings. It should be emphasized that the following description is merely exemplary and is not intended to limit the scope of the invention and its applications.

### The Basic Principle of the Invention

The invention transfers the depth information (phase information) of the fastener surface into the light intensity distribution of the fringe interferogram through laser irradiation, “shearing”, “subtracting” and other steps, thus overcomes the traditional technical prejudice, abandoning the traditional, backward thinking inertia (i.e., relying on the mathematical correspondence between light intensity distribution and phase information in the fringe interferogram; therefore, the phase information must first be solved from the light intensity distribution to calculate the depth information under the measured surface, which leads to slow detection speed and low detection accuracy).

On the contrary, in prior art, the frequency of light is too high, which exceeds the resolution ability of ordinary cameras; therefore, ordinary cameras can't directly capture the phase information about fasteners.

According to an embodiment of the present invention, a laser is emitted, which passes through a beam expander to form a larger diameter laser output beam and irradiates a rough surface of the fastener; the reflected light from the rough surface of the fastener passes through a means for making two shearing beams interfered (e.g., a shearing device) to form a speckle texture map (e.g., a shearing speckle pattern); the pattern is recorded by a CCD and transmitted to a computer for storage.

The fringe interferogram (e.g., speckle fringe pattern) obtained through a “shearing”, a “subtracting” and other steps converts the depth information (phase information) of the measured surface into the light intensity matrix (e.g., light intensity distribution) of the pattern.

Therefore, according to the correspondence between the different states of the fasteners (with different depth information) and the different types of the fringe interferograms (i.e., speckle fringe map showing a light intensity distribution) established in the machine learning training model, the fringe interferogram is used to directly inspect the fastener state.

### The Principle of Interference Image Formation

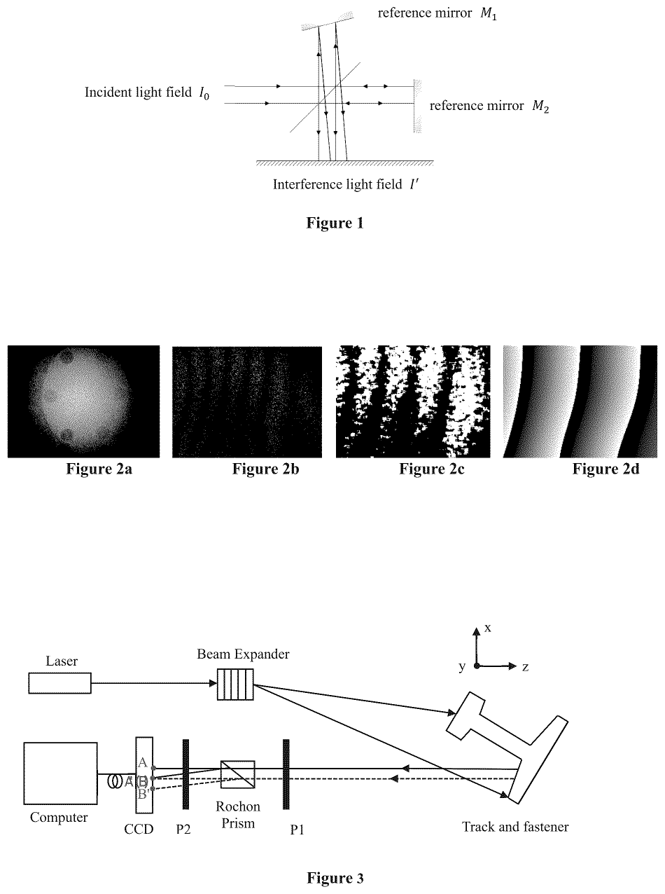

“Shearing” is generated by a shearing device, through which a certain misalignment between the reference light and the interfering light is generated on the imaging surface, thus resulting in interference. In one embodiment, as shown in FIG. 1, the reference mirror M1 of the Michelson interferometer is rotated by a certain angle, so that the two reflected beams are slightly misaligned on the imaging surface, thus resulting in interference.

In the present invention, common shearing devices include but are not limited to Michelson interferometer; biprism, Rochon prism, Wollaston prism, and other prisms; Ronchi grating, cross-grating, and other gratings; and liquid crystal spatial light modulator, etc.

### Speckle Processing:

In the present invention, the original speckle texture map (irregular randomly distributed speckles, as shown in FIG. 2a below) is captured by a CCD and stored in the computer. The speckle texture map (e.g., shearing speckle pattern) when the fastener under test is not yet deformed is recorded as F₁; after the deformation, the speckle texture map of the Nth frame is recorded as F_{N}. Using F₁ minus F_{N}, the corresponding fringe interferogram F_{N}′ of the Nth frame is obtained (regular black and white fringes, FIG. 2b below), the fringe interferogram (e.g., the speckle fringe pattern) records the phase information of the fastener surface under test, that is, the depth information; the depth difference between the adjacent dark and dark fringes (or bright and bright fringes) is the wavelength of the emitted laser.

### Data Processing:

In the traditional shearing speckle pattern interferometry measurement, the wrapped phase information (FIG. 2d) is obtained by phase extraction technique from the fringe interferogram after filtering, normalization, binarization and other operations (FIG. 2c); then using the phase unwrapping technique, the unwrapped phase information corresponding to the measured surface is obtained. Then, using the correspondence between the unwrapped phase information and the depth information (for every 2π change in phase, the depth changes by one laser wavelength), the depth change information of the measured surface is recovered.

In the present invention, the above depth change information is no longer recovered by strict mathematical methods, and no longer contains steps such as binarization and subsequent unwrapping; the fringe interferogram after subtraction is processed and compared directly with the stored images in the model, allowing the machine to “see” directly, and no longer making the computer to “calculate”. This is an obvious difference between the present invention and the prior art.

### Meaning of the Term “Shearing”:

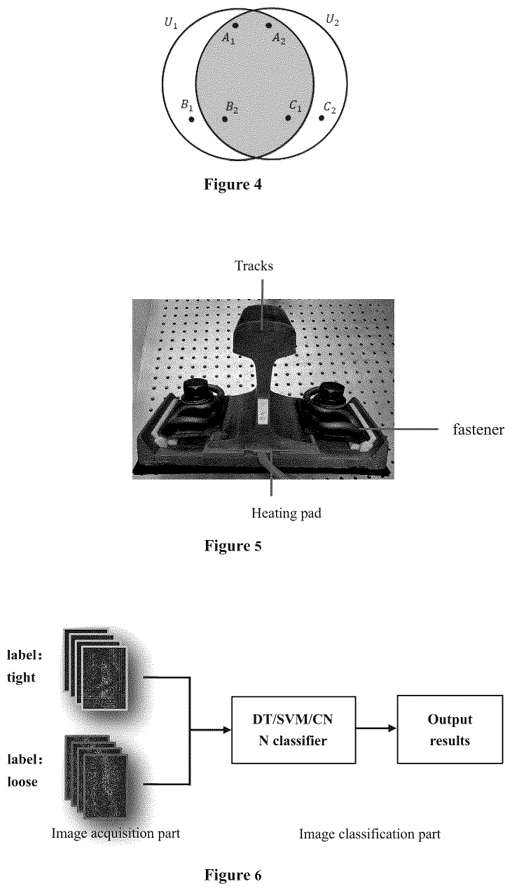

The original wavefront is “sheared” to form two wavefronts that are identical in waveform and only slightly different in spatial location. The speckle texture map (dark area in FIG. 4) acquired on the CCD surface is the result of the shearing of the two wavefronts. The term “shearing” doesn't refer to any selection or interception of a part of the whole.

### Model Training and Application:

For a new system formed by using fasteners to connect various parts together, to ensure that the fasteners work in a normal state, the automatic detection method of fastener loosening state according to the present invention comprises:
1) data acquisition equipment: for example, selecting a single longitudinal mode semiconductor laser with a wavelength of 532 nm as a light source, its output laser is filtered and expanded by a spatial filter and irradiated on the surface of the new system to form a laser speckle. The laser speckle reflected from the measured surface passes through a shearing device (e.g., through polarizer 1, Rochon prism, and polarizer 2 in sequence), and the speckle texture map is acquired using a camera and transmitted to a computer.
2) Model training: apply suitable load to the fastener system, while start to acquire images and transfer them to the computer; stop applying load after reaching the critical state until the fastener system returns to the initial state and stop image acquisition. Repeat the above steps until enough patterns of the fastener in normal state are acquired. Loosen the fastener, repeat the above steps until enough patterns of the fastener in the loose state are acquired. Randomly select a huge number of patterns from the acquired patterns as the original data set, ensuring that the patterns in the normal state of the fastener and the patterns in the loose state are 50% each. The computer is used to filter and normalize the speckle texture maps. The patterns are labeled with normal state and loose state respectively. The original data set is put into the machine learning algorithm model as the training set for training, and the model is saved.
3) Model application: perform the acquisition of patterns on the actual fastener system. After filtering and normalizing the images into the trained model, the model will directly output the results to complete the detection of the fastener state.

### Embodiments

### 1. Design Objectives and Design Principles

The fastener system on the railroad is uniform, and the application market is very large and representative. Temperature change is one of the representative loads that fasteners are often subjected to, for example, the maximum temperature of the rail system in summer is about 60° C.

For the fasteners used on the railroad, Spring clip-II fastenings are widely used in China's ballastless track, with the advantages of high buckling pressure, large strength safety reserve, small residual deformation. For the rail, at present, for example, main line railroads generally use 60 kg/m standard rail, widely used.

### 2. Fasteners and Rails

A steel rail, a heating plate, a heat insulation plate and a cast iron pad are assembled together by fasteners, as shown in FIG. 5.

### 3. Overall Testing System

The overall process of fastener loosening detection is shown in FIG. 6 below. First, the image acquisition system obtains the fringe interferograms generated by the deformation of the rail in the two states of fastening and loosening. After labeled and pre-processing, three different machine learning algorithms: decision tree, support vector machine and convolutional neural network are used to process the images and output the detection results to complete the detection of fastener looseness.

### 3.1 Image Acquisition Part

The present invention uses a digital shearing speckle pattern interference system as shown in FIG. 3 to acquire speckle texture maps in different states.

The laser emitted from the semiconductor laser is scattered onto the surface of the tracks after passing through the beam expander. After being reflected by the rough surface of the tracks, it passes through polarizer 1, Rochon prism and polarizer 2, finally captured by the CCD, and the images are stored in the computer. Two coherent beams generated by the Rochon prism interfered on the surface of CCD, the intensity distribution of CCD can be expressed as:

$$I = {I}_{0} ( 1 + γ cos {φ}_{0} ) \qquad ( 1 )$$

where I₀ is the intensity of background light, γ is the modulation, and φ₀ is the random phase angle.

Those skilled in the art know that when the track surface is deformed, the optical path difference and phase difference also change. The light intensity of the speckle patterns will also change, but due to the presence of random phase φ₀, the fringes cannot be observed directly, and the images directly captured by CCD are still randomly distributed irregular speckle patterns. In DSSPI, the fringe pattern can be observed after the subtraction of the intensity before and after deformation. The absolute value of the intensity Iₛ after the digital subtraction between the intensity before deformation I₁ and after deformation I₂ can be expressed as:

$$\vert {I}_{S} \vert = \vert {I}_{1} - {I}_{2} \vert = \vert 4 {I}_{0} γ [ sin ( {φ}_{0} + ( {φ}_{0} + \frac{Δ φ}{2} ) sin ( \frac{Δ φ}{2} ) ] \vert \qquad ( 2 )$$

where Δφ is the relative phase difference caused by deformation. According to formula (2), a visible fringe pattern of DSSPI is obtained after subtraction: when Δφ=2nπ, |Iₛ|=0, the black interference fringes appear (n=0,1±1,±2, . . . , for the fringe order).

The intensity distribution of the CCD surface is sensitive to the gradient of the out-of-plane deformation of the measured surface. If the shear is along the x-direction (vertical direction, which allows an angle between the shear direction and the line of symmetry of the rail section; in the inspection process, allowing the angle to fluctuate in a small range, and doesn't affect the accuracy of inspection, which is another feature of the invention differs from the prior art), the relationship between the gradient of the out-of-plane deformation and the phase difference Δφ can be expressed as:

$$\frac{\partial ω}{\partial x} = \frac{λΔ φ}{4 π Δ x} \qquad ( 3 )$$

where ∂ω/∂x is the derivative of the out-of-plane displacement along the x-direction, λ is the wavelength of the laser, and Δx is the shear amount (the distance between A and A′, or B and B′ in FIG. 3). Δφ is the relative phase difference caused by deformation, which is calculated from formula (2).

Δx is a known quantity, so the derivative of the out-of-plane displacement ∂ω/∂x along the x direction can be solved according to formula (3) above after obtaining the phase difference Δφ. The derivative of the out-of-plane displacement ∂ω/∂x is integrated along the x direction to obtain the out-of-plane displacement ω (i.e., depth information ω).

In other words, we can calculate the out-of-plane displacement ω by recovering Δφ.

This indicates that the speckle texture maps contain depth information, implying that the proposed fastener looseness inspection which requires depth information is theoretically feasible.

However, in conventional digital shearing speckle pattern interferometry, the out-of-plane displacement ω must be calculated by recovering the phase difference Δφ. The problem is that phase extraction is a key step in interferometry, but phase unwrapping is very complicated and has many limitations, especially for two-dimensional surface shapes. According to formula (2), the change of phase difference Δφ causes a change in the light intensity distribution |Iₛ| of the fringe interferogram, which is manifested in the image as the fringe interferogram differs from the fringe interferogram obtained for the fastener in the normal state. Fasteners in different states lead to different fringe interferograms obtained, however, it is difficult for humans to generalize and classify them.

Instead, the present invention skips the complicated phase extraction step in the prior art and uses machine learning to directly establish the relationship between the fringe interferogram and the fastener state; the working state detection of the fastener is accomplished by directly classifying the obtained fringe interferogram. In other words, the invention avoids complex mathematical operations and speeds up the recognition; moreover, the invention directly carries out image recognition, realizes artificial intelligence (AI), and can even recognize the critical state before loosening, and the speed of “reading” and the accuracy of “judgment” can easily surpass human beings.

According to the present invention, the device for inspecting a loosening status of service fasteners can be installed on a special vehicle or an operating vehicle, and a single device can detect numerous fasteners in real time and on a large scale. It avoids the disadvantage of the prior art of having to install multiple inspection devices, which can only detect a localized area and must pay a high cost.

### 3.2 Image Processing Part

### 3.2.1 DT-Based Loosening Inspection

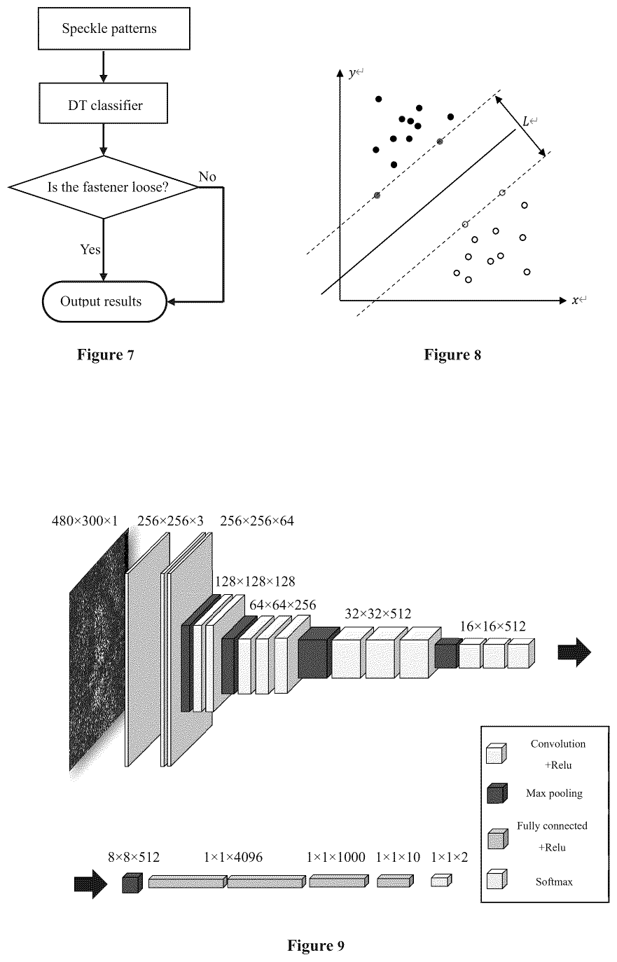

DT classifies images by extracting features of the target images. In DT, each node represents a feature value and each leaf node represents the classification result that can be judged by this node. The decision tree of the invention is shown in FIG. 7 below, and it is only necessary to input the captured fringe interferograms into the decision tree classifier to directly determine the fastener loosening state.

In one embodiment of the present invention, the grayscale histogram of the acquired image is selected as a feature of the DT model. In the pre-training process, the DT model calculates the grayscale histogram of all training set samples and establishing the association with the corresponding sample's label (fastened or loose). Then the DT model automatically classifies the calculated grayscale histogram into two types (the judgment basis is automatically learned and selected by the model) indicating the fastener's fastened or loose state, respectively. By directly establishing the association between grayscale histogram types and fastener states, the task of state detection by calculating grayscale histograms is accomplished. In practice, it is only necessary to input the acquired fringe interferogram into the decision tree model, which calculates the grayscale histogram features of the image and classifies the grayscale histogram according to the judgment basis learned from the training set to complete the state detection for fasteners.

### 3.2.2 SVM-Based Loosening Inspection

SVM is a powerful mathematical model for classification and regression. As shown in FIG. 8, the basic idea of SVM is to transform original data into multidimensional space and construct the hyperplane that can correctly classify different classes with the largest geometric interval L. In the present invention, linear classification of fringe interferograms is achieved by extracting the grayscale histogram features of the images.

In one embodiment of the present invention, the grayscale histogram of the acquired image is selected as a feature of the SVM model. In the pre-training process, the SVM model calculates the grayscale histogram of all training set samples and establishing the association with the corresponding sample's label (fastened or loose). Then the SVM model automatically classifies the calculated grayscale histogram into two types (the judgment basis is automatically learned and selected by the model) indicating the fastener's fastened or loose state, respectively. By directly establishing the association between grayscale histogram types and fastener states, the task of state detection by calculating grayscale histograms is accomplished. In practice, it is only necessary to input the acquired fringe interferogram into the decision tree model, which calculates the grayscale histogram features of the image and classifies the grayscale histogram according to the judgment basis learned from the training set to complete the state detection for fasteners.

### 3.2.3 CNN-Based Loosening Inspection

CNN is one of the representative algorithms of deep learning and is the most advanced image classification algorithm. The proper selection of feature is challenging task of classification. Unlike the previous two algorithms, CNN has feature learning capability, which means that it doesn't require us to extract features manually, but rather the algorithm does so. VGG-16 network, as a classical algorithm for image classification, has demonstrated excellent performance in the field of image classification. In this paper, we use the modified VGG-16 network to complete the binary classification of the input images and realize the inspection of the fastener looseness status. The architecture of the modified VGG-16 network is shown in FIG. 9, which contains 14 convolutional layers, 4 max-pooling layers, 4 fully connected layers, and a SoftMax layer.

The convolutional layer consists of several convolutional units, and the parameters of each convolutional unit are optimized by a backpropagation algorithm, whose role is to extract the information of the input image, that is, to extract the features of the image. The role of the maximum pooling layer is to select the image features in the convolutional layer that are not disturbed by the position; to reduce the dimensionality of the features to improve the perceptual field of subsequent features; and to reduce the number of variables in the feature map to reduce the computational effort. The fully-connected layer transforms all feature matrices of the pooling layer into one-dimensional feature large vectors and performs dimensionality reduction on the data. SoftMax layer is to transform the vector values of the previous output into a probabilistic representation, with the purpose of representing the classification results in a probabilistic form and completing the classification of images.

What is different from the first two algorithms is that CNN have feature learning capability. During the pre-training of the convolutional neural network model, its not necessary to specify features as the basis for judgment, but the model itself automatically selects one or more features (chosen by the model itself for learning, and humans don't know exactly which features) as the best basis for judgment in the process of iteration, and establishes a direct connection between this or these features and the fastener state, relying on the optimal features chosen by these models to classify the image and achieve fastener state detection. In practice, the pattern obtained is input into the CNN model, which calculates and classifies the selected features of the image to finally realize the status detection of fasteners.

For the loosening detection of fasteners in railroad systems, the loosening detection of fasteners in railroad systems can be accomplished by using a trained model.

For the loosening detection of fasteners in other situations such as factory pipes, it is difficult to train a model that can adapt to all fastener loosening detection situations. Different models need to be trained for different usage scenarios. It is also possible to train a model that can cope with multiple scenarios.

The fasteners in the railroad system have different positions or angles during installation, resulting in some distortion of the captured images, so it is also possible to add new images to adapt to the problem by scaling, flipping, and random cropping of the original images during the preliminary model training (this method is also applicable to the case where there is no sufficient data set).

The more training data the AI model has, the better the model, the higher the judgment accuracy and the better the generalizability.

For the present invention, continued learning can be achieved for continuous self-improvement. In other embodiments of the present invention, for example:
1) for DT models and SVM models or other machine learning models, other features or multiple combined features can be selected as a basis for judgment to find the best feature that explains the relationship between the target variable and the independent variable.
2) multi-scale training for CNN models, i.e., inputting images of different scales and using the special characteristics of convolutional pooling of neural networks to allow the neural networks to fully learn the features of images at different resolutions in order to improve the performance of machine learning.
3) Using more different algorithms or models.
4) Integrating and combining multiple algorithms or models together to obtain better results.

According to the present invention, not only the surface state of the fastener, but also the state at a certain depth below the surface, can be detected; not only the traditional manual inspection level can be reached, but also the traditional manual inspection can be surpassed in terms of speed and quality, which is an surprised technical effect over prior art.

The inspection device according to the present invention can be installed on a surveillance vehicle, and even a special inspection vehicle can be designed.

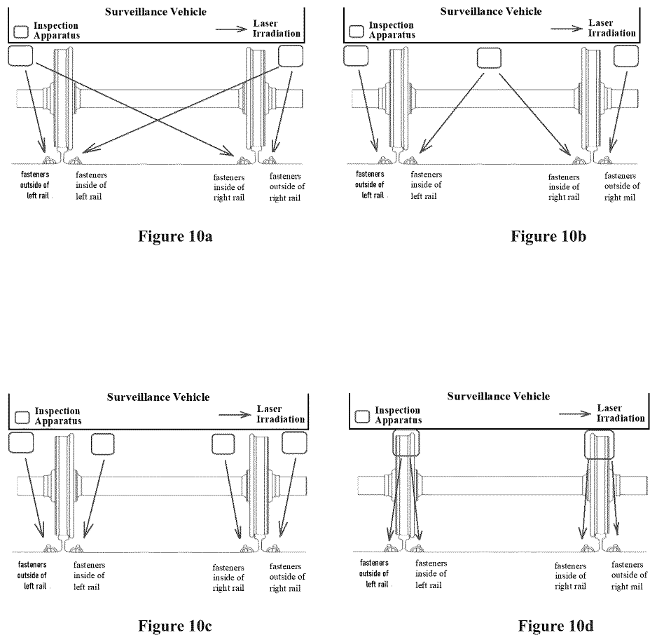

As shown in FIG. 10a, two sets of laser irradiation and surface array camera systems can be set up, one set for simultaneously irradiating the fasteners on the outside of the left rail and the fasteners on the inside of the right rail, and the other set for simultaneously irradiating the fasteners on the outside of the right rail and the fasteners on the inside of the left rail.

As shown in FIG. 10b, three sets of laser irradiation and surface array camera systems can also be set up, one set for irradiating the fasteners on the outside of the left rail, one set for irradiating the fasteners on the outside of the right rail, and one set for simultaneously irradiating the fasteners on the inside of the left rail and the fasteners on the inside of the right rail.

As shown in FIG. 10c, four sets of laser irradiation and surface array camera systems can be set up, one set for irradiating the fasteners on the outside of the left rail, one set for irradiating the fasteners on the inside of the left rail, one set for irradiating the fasteners on the inside of the right rail, and one set for irradiating the fasteners on the outside of the right rail.

As shown in FIG. 10d, two laser irradiation and surface array camera systems can be set up, one for irradiating both the outer left rail fasteners and the inner left rail fasteners, and the other for irradiating both the inner right rail fasteners and the outer right rail fasteners.

In practice, the embodiment as shown in FIG. 10c is preferred.

The technical solution of the present invention is not easily derived with such a fact that the prior art uses a two-dimensional image of the fastener damage or loss detection method, the two-dimensional image is taken from directly above, which doesn't contain the depth information of the fastener and its surroundings, so that it can't complete the loosening inspection of the fastener requiring depth information. Therefore, no researcher has previously used 2D image detection or classification for fastener loosening detection. However, the light intensity distribution of the fringe interferogram acquired by the digital shearing speckle interference technique in this invention contains depth information, which can provide a good solution for fastener loosening detection requiring depth information. This provides theoretical feasibility for fastener loosening detection that requires depth information.

Two-dimensional images don't contain depth information, so no one uses this for fastener loosening detection because depth information is required.

In addition, two-dimensional image classification does not require complex computation, but direct “see”, which is much faster than the three-dimensional vision method.

The digital shearing speckle pattern interferometry of the present invention measures stress or strain directly.

When the state of the fastener is changed and not yet deformed, the stress or strain of the measured surface has changed and can be directly detected by this technique. However, at this time, no deformation has occurred, and traditional 3D vision-based methods can't detect that the state of the fastener has changed.

On the contrary, in prior art, the traditional idea is to measure the displacement or deformation, and it is impossible to sense or measure the special state where the stress has changed but the deformation has not yet occurred. It is impossible to perceive or measure the special state where the stress has changed but not yet deformed. This special state can be seen essentially as a state of minimal or small looseness.

According to the present invention, the learning of the fringe interferograms for different degrees of loosening of the fastener is done later in the process, including the learning of the loosened. The model will be able to judge not only whether the fastener is loose or not, but also the degree of looseness of the fastener and identification, and issue early warning or alarm.

1. A method for AI real-time inspecting a loosening status of a fastener, wherein
a stress or strain of the fastener is used to detect whether the fastener is in a loosening situation (instead of testing a displacement or deformation as in prior art);
a light intensity matrix of the fastener and its adjacent surfaces is obtained by means of a laser irradiation and area scan cameras, so as to detect any loosening condition below the fastener surface and its adjacent surface (abandoning any conventional natural light camera in prior art);
a correspondence between a speckle texture map and a fastener status is established directly through Machine Learning of AI; and any loosening status of the fastener is found through a direct identification by comparing an obtained speckle texture map with an AI model (a phase extraction technique in prior art is discarded);
through learning those speckle texture maps under different degrees of loosening status of in situ fasteners, also learning of such a state that any fastener is to be loosening but has not yet deformed, the AI model can not only determine whether any fastener is loosening, but also judge and identify a degree of loosening and make an early warning or alarming.

2. The method of claim 1, wherein
a laser beam is emitted by a laser, to pass through a beam expander so as to form a larger diameter output laser beam and irradiate a rough surface of the fastener and its adjacent area; a reflected light from the rough surface of the fastener and its adjacent area passes through a means for making an image interfered with itself to form a speckle interferogram; then the speckle interferogram is recorded by a CCD and transmitted to a computer for storage and image processing.

3. The method of claim 1, wherein
a CCD collects an original speckle texture map before deformation of the fastener and a distorted speckle texture map after deformation of the fastener; the original speckle texture map is subtracted from the distorted speckle texture map, so as to obtain a speckle texture interferogram which records phase data of a measured surface to test any loosening condition below the measured surface.

4. The method of claim 2, wherein
a means for making an image interfered with itself is used to make a misalignment between a reference light and an object light on an imaging surface, producing a speckle interferogram; preferably, a reference mirror of a Michelson interferometer is rotated by an angle, making two reflected beams of the reference light and the object light, respectively, are misaligned on an imaging surface, thereby forming an interference of an image.

5. The method of claim 1, wherein a training process for the Machine Learning of AI comprises:
applying different loads from a zero-load to a critical load at different working conditions to a system installed with fasteners, and at the same time, acquiring images of physical parameter changes of the fasteners (e.g., a stress or strain speckle interferon texture) and transmitting them into a computer; stopping application of any load upon each cycle of loading reaches its critical state until a fastener system returns to its initial state and stopping any image acquisition; and repeating loading and unloading operations until obtaining sufficient fastener images of physical parameter changes in a normal status;
loosening the fastener to make the fastener at a loosened status; and repeating above loading, unloading and image acquiring operations until taking sufficient images of physical parameter changes in some loosening status of the fastener;
selecting a large number of images randomly from those physical parameter change images acquired during the training process as an original data set, to ensure that the images in the normal status of the fastener and the images in the loosened status each account for about 50%;
performing filtering, normalizing and other operations on the physical parameter change images using a computer; to label all of the physical parameter change images with a “normal status” or a “loosened status”, respectively; or, to directly label the images of fasteners in the normal status in an opinion of humans with the “normal status” and the images of fasteners in the loosened status in an opinion of humans with the loose status;
putting the original data set as a training set into an AI judgment model for training the same, then saving the AI judgment model after every training.

6. An apparatus for implementing the method of claim 1, wherein the apparatus comprises:
a laser, which is mounted at a position capable of irradiating the fastener;
a spatial filter and beam expander, which is set in a laser path between the laser and the fastener so as to filter and expand the laser beam;
an image forming device, which forms two identical, interfering images with a phase difference;
an image receiving device, which uses an area scan camera; and
a computer, which is provided with an AI judgment model for real-time inspecting a fastener loosening status, in which any detected image keeps being filtered, normalized and put into the AI judgment model keeping used and trained, and the AI judgment model detects the fastener for its loosening status in real-time.

7. The apparatus of claim 6, wherein the laser is preferably a single longitudinal mode semiconductor laser with a wavelength of 532 nm.

8. The apparatus of claim 6, wherein the image forming device preferably comprises two polarizers and a Rochon prism.

9. An inspection apparatus for implementing the method of claim 1, wherein the inspection apparatus is mounted on an operating vehicle, the inspection apparatus comprises:
a laser, which is used to irradiate one of the fasteners after another when the operating vehicle is moving.
a spatial filter and beam expander, which is set in a laser path between the laser and the fastener to filter and expand the laser beam;
an image forming device, which forms two identical, interfering images with a phase difference;
an image receiving device, which uses an area scan camera; and
a computer, which is provided with an AI judgment model for real-time inspecting those fasteners for their loosening status, in which any detected image keeps being filtered, normalized and put into the AI judgment model keeping used and trained, and the AI judgment model detects those fasteners for their loosening status in real-time.

10. A surveillance vehicle for implementing the method of claim 1, wherein the surveillance vehicle comprises:
a laser, which is irradiating one of the fasteners after another during the surveillance vehicle is moving;
a spatial filter and beam expander, which is set in a laser path between the laser and the fastener to filter and expand the laser beam;
an image forming device, which forms two identical, interfering images with a phase difference;
an image receiving device, which uses an area scan camera; and
a computer, which is provided with an AI judgment model for real-time inspecting those fasteners for their loosening status, in which any detected image keeps being filtered, normalized and put into the AI judgment model keeping used and trained, and the AI judgment model detects those fasteners for their loosening status in real-time.

11. An apparatus for implementing the method of claim 2, wherein the apparatus comprises:
a laser, which is mounted at a position capable of irradiating the fastener;
a spatial filter and beam expander, which is set in a laser path between the laser and the fastener so as to filter and expand the laser beam;
an image forming device, which forms two identical, interfering images with a phase difference;
an image receiving device, which uses an area scan camera; and
a computer, which is provided with an AI judgment model for real-time inspecting a fastener loosening status, in which any detected image keeps being filtered, normalized and put into the AI judgment model keeping used and trained, and the AI judgment model detects the fastener for its loosening status in real-time.

12. An apparatus for implementing the method of claim 3, wherein the apparatus comprises:
a laser, which is mounted at a position capable of irradiating the fastener;
a spatial filter and beam expander, which is set in a laser path between the laser and the fastener so as to filter and expand the laser beam;
an image forming device, which forms two identical, interfering images with a phase difference;
an image receiving device, which uses an area scan camera; and
a computer, which is provided with an AI judgment model for real-time inspecting a fastener loosening status, in which any detected image keeps being filtered, normalized and put into the AI judgment model keeping used and trained, and the AI judgment model detects the fastener for its loosening status in real-time.

13. An apparatus for implementing the method of claim 4, wherein the apparatus comprises:
a laser, which is mounted at a position capable of irradiating the fastener;
a spatial filter and beam expander, which is set in a laser path between the laser and the fastener so as to filter and expand the laser beam;
an image forming device, which forms two identical, interfering images with a phase difference;
an image receiving device, which uses an area scan camera; and
a computer, which is provided with an AI judgment model for real-time inspecting a fastener loosening status, in which any detected image keeps being filtered, normalized and put into the AI judgment model keeping used and trained, and the AI judgment model detects the fastener for its loosening status in real-time.

14. An apparatus for implementing the method of claim 5, wherein the apparatus comprises:
a laser, which is mounted at a position capable of irradiating the fastener;
a spatial filter and beam expander, which is set in a laser path between the laser and the fastener so as to filter and expand the laser beam;
an image forming device, which forms two identical, interfering images with a phase difference;
an image receiving device, which uses an area scan camera; and
a computer, which is provided with an AI judgment model for real-time inspecting a fastener loosening status, in which any detected image keeps being filtered, normalized and put into the AI judgment model keeping used and trained, and the AI judgment model detects the fastener for its loosening status in real-time.

15. An inspection apparatus for implementing the method of claim 2, wherein the inspection apparatus is mounted on an operating vehicle, the inspection apparatus comprises:
a laser, which is used to irradiate one of the fasteners after another when the operating vehicle is moving.
a spatial filter and beam expander, which is set in a laser path between the laser and the fastener to filter and expand the laser beam;
an image forming device, which forms two identical, interfering images with a phase difference;
an image receiving device, which uses an area scan camera; and
a computer, which is provided with an AI judgment model for real-time inspecting those fasteners for their loosening status, in which any detected image keeps being filtered, normalized and put into the AI judgment model keeping used and trained, and the AI judgment model detects those fasteners for their loosening status in real-time.

16. An inspection apparatus for implementing the method of claim 3, wherein the inspection apparatus is mounted on an operating vehicle, the inspection apparatus comprises:
a laser, which is used to irradiate one of the fasteners after another when the operating vehicle is moving.
a spatial filter and beam expander, which is set in a laser path between the laser and the fastener to filter and expand the laser beam;
an image forming device, which forms two identical, interfering images with a phase difference;
an image receiving device, which uses an area scan camera; and
a computer, which is provided with an AI judgment model for real-time inspecting those fasteners for their loosening status, in which any detected image keeps being filtered, normalized and put into the AI judgment model keeping used and trained, and the AI judgment model detects those fasteners for their loosening status in real-time.

17. An inspection apparatus for implementing the method of claim 4, wherein the inspection apparatus is mounted on an operating vehicle, the inspection apparatus comprises:
a laser, which is used to irradiate one of the fasteners after another when the operating vehicle is moving.
a spatial filter and beam expander, which is set in a laser path between the laser and the fastener to filter and expand the laser beam;
an image forming device, which forms two identical, interfering images with a phase difference;
an image receiving device, which uses an area scan camera; and
a computer, which is provided with an AI judgment model for real-time inspecting those fasteners for their loosening status, in which any detected image keeps being filtered, normalized and put into the AI judgment model keeping used and trained, and the AI judgment model detects those fasteners for their loosening status in real-time.

18. An inspection apparatus for implementing the method of claim 5, wherein the inspection apparatus is mounted on an operating vehicle, the inspection apparatus comprises:
a laser, which is used to irradiate one of the fasteners after another when the operating vehicle is moving.
a spatial filter and beam expander, which is set in a laser path between the laser and the fastener to filter and expand the laser beam;
an image forming device, which forms two identical, interfering images with a phase difference;
an image receiving device, which uses an area scan camera; and
a computer, which is provided with an AI judgment model for real-time inspecting those fasteners for their loosening status, in which any detected image keeps being filtered, normalized and put into the AI judgment model keeping used and trained, and the AI judgment model detects those fasteners for their loosening status in real-time.

19. A surveillance vehicle for implementing the method of claim 2, wherein the surveillance vehicle comprises:
a laser, which is irradiating one of the fasteners after another during the surveillance vehicle is moving;
a spatial filter and beam expander, which is set in a laser path between the laser and the fastener to filter and expand the laser beam;
an image forming device, which forms two identical, interfering images with a phase difference;
an image receiving device, which uses an area scan camera; and
a computer, which is provided with an AI judgment model for real-time inspecting those fasteners for their loosening status, in which any detected image keeps being filtered, normalized and put into the AI judgment model keeping used and trained, and the AI judgment model detects those fasteners for their loosening status in real-time.

20. A surveillance vehicle for implementing the method of claim 3, wherein the surveillance vehicle comprises:
a laser, which is irradiating one of the fasteners after another during the surveillance vehicle is moving;
a spatial filter and beam expander, which is set in a laser path between the laser and the fastener to filter and expand the laser beam;
an image forming device, which forms two identical, interfering images with a phase difference;
an image receiving device, which uses an area scan camera; and
a computer, which is provided with an AI judgment model for real-time inspecting those fasteners for their loosening status, in which any detected image keeps being filtered, normalized and put into the AI judgment model keeping used and trained, and the AI judgment model detects those fasteners for their loosening status in real-time.
